(19) United States
(12) Patent Application Publication
(10) Pub. No.: US 2007/0110405 A1
(43) Pub. Date: May 17, 2007

(54) Information recording device and electronic instrument

(75) Inventor: Yoshimasa Kondo, Matsumoto (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/598,892

(22) Filed: Nov. 14, 2006

(30) Foreign Application Priority Data
Nov. 15, 2005 (JP) 2005-330538
Nov. 8, 2006 (JP) 2006-302698

(51) Int. Cl. H04N 7/26

(52) U.S. Cl. 386/112

(57) ABSTRACT

An information recording device includes a TS separation section which extracts a first TS packet for generating image data as reproduction data, a second TS packet for generating sound data as reproduction data, and a third TS packet other than the first and second TS packets from a transport stream, and a memory including first to third memory areas in which the first to third TS packet are stored. The TS separation section extracts the first and second TS packets based on analysis results of the third TS packet extracted from the transport stream. The first and second TS packets read from the first and second memory areas are multiplexed and generated as MP4 data, 3GP data or 3G2 data.

Japanese Patent Application No. 2005-330538 filed on Nov. 15, 2005, and Japanese Patent Application No. 2006-302698 filed on Nov. 8, 2006 are hereby incorporated by reference in their entirety.

### BACKGROUND OF THE INVENTION

The present invention relates to an information reproducing device and an electronic instrument.

Digital terrestrial broadcasting introduced to replace analog terrestrial broadcasting is expected to provide various new services in addition to increasing the image and sound quality. A service for portable terminals called “one-segment broadcasting” is one of the new services provided accompanying the introduction of digital terrestrial broadcasting. According to one-segment broadcasting, digital modulated waves modulated by quadrature phase shift keying (QPSK) are multiplexed by orthogonal frequency division multiplexing (OFDM) so that a portable terminal can stably receive broadcasting even during movement.

A portable telephone is an example of such a portable terminal. When adding a one-segment broadcasting receiving function to a portable telephone, it is necessary to cause the portable telephone to separate a transport stream, in which compressed image data and sound data are multiplexed, and to decode the separated data. In this case, it is necessary to incorporate a high-performance additional device in the portable telephone, whereby power consumption is increased. As a result, the battery run time of the portable terminal may be reduced.

For example, JP-A-8-130745 discloses a configuration in which a plurality of low-performance processors are provided in parallel to perform decoding according to the Moving Picture Experts Group Phase 2 (MPEG-2) standard. Specifically, image signals encoded according to the MPEG-2 standard are separated into a plurality of bitstreams, and each bitstream is subjected to variable-length decoding and motion compensation to make it unnecessary to increase the performance of the processor which realizes each processing.

### SUMMARY

According to one aspect of the invention, there is provided an information recording device for recording data included in a transport stream, the information recording device comprising:

a separation section which extracts a first transport stream (TS) packet for generating image data as reproduction data, a second TS packet for generating sound data as reproduction data, and a third TS packet other than the first and second TS packets from the transport stream; and

a memory including a first memory area in which the first TS packet is stored, a second memory area in which the second TS packet is stored, and a third memory area in which the third TS packet is stored;

the separation section extracting the first and second TS packets based on analysis results of the third TS packet extracted from the transport stream; and

the first and second TS packets read from the first and second memory areas being multiplexed and generated as Moving Picture Experts Group phase 4 data, 3rd Generation Partnership Project data or 3rd Generation Partnership Project 2 data (MP4 data, 3GP data or 3G2 data).

According to another aspect of the invention, there is provided an information recording device for recording data included in a transport stream, the information recording device comprising:

a separation section which extracts a first transport stream (TS) packet for generating image data as reproduction data, a second TS packet for generating sound data as reproduction data, and a third TS packet other than the first and second TS packets from the transport stream; and

a memory including a first memory area in which the first TS packet is stored, a second memory area in which the second TS packet is stored, and a third memory area in which the third TS packet is stored;

the separation section extracting the first and second TS packets based on analysis results of the third TS packet extracted from the transport stream; and

the second TS packet read from the second memory area being generated as Moving Picture Experts Group Phase 2 Advanced Audio Coding (MPEG-2 AAC) data.

According to a further aspect of the invention, there is provided an information recording device for recording data included in a transport stream, the information recording device comprising:

a separation section which extracts a first transport stream (TS) packet for generating image data as reproduction data, a second TS packet for generating sound data as reproduction data, and a third TS packet other than the first and second TS packets from the transport stream;

a memory including a first memory area in which the first TS packet is stored, a second memory area in which the second TS packet is stored, and a third memory area in which the third TS packet is stored; and

an image decoder which performs image decoding which generates image data based on the first TS packet read from the first memory area;

the separation section extracting the first and second TS packets based on analysis results of the third TS packet extracted from the transport stream; and

compressed still image data being generated based on the image data generated by the image decoder.

According to a further aspect of the invention, there is provided an information recording device for recording data included in a transport stream, the information recording device comprising:

a memory including a sixth memory area in which TS data including a first transport stream (TS) packet for generating image data as reproduction data, a second TS packet for generating sound data as reproduction data, and a third TS packet other than the first and second TS packets is stored, the information recording device directly generating the TS data read from the sixth the memory area.

According to a further aspect of the invention, there is provided an electronic instrument comprising:

one of the above information recording devices; and

a host which analyzes the third TS packet extracted from the transport stream, and generates the AAC data, the MPEG-2 AAC data, or the compressed data.

According to a further aspect of the invention, there is provided an electronic instrument comprising:

a tuner;

one of the above information recording devices to which a transport stream from the tuner is supplied; and

a host which analyzes the third TS packet extracted from the transport stream, and generates the AAC data, the MPEG-2 AAC data, or the compressed data.

### BRIEF DESCRIPTION OF THE SEVERAL VIEWS OF THE DRAWING

FIG. 1 is a view illustrative of the concept of segments of digital terrestrial broadcasting.

FIG. 2 is a view illustrative of a transport stream (TS).

FIG. 3 is a view illustrative of a PES packet and a section.

FIG. 4 is a block diagram of a configuration example of a portable telephone including a multimedia processing CPU according to a comparative example of one embodiment of the invention.

FIG. 5 is a block diagram of a configuration example of a portable telephone including an information reproducing device according to one embodiment of the invention.

FIG. 6 is a block diagram of a configuration example of an image processing IC shown in FIG. 5.

FIG. 7 is a view illustrative of the operation of the image processing IC shown in FIG. 6.

FIG. 8 is a flow diagram of an operation example of reproduction processing of a host CPU.

FIG. 9 is a flow diagram of a processing example of broadcast reception start processing shown in FIG. 8.

FIG. 10 is a view illustrative of the operation of the image processing IC shown in FIGS. 6 and 7 during the broadcast reception start processing.

FIG. 11 is a flow diagram of a processing example of broadcast reception finish processing shown in FIG. 8.

FIG. 12 is a view illustrative of the operation of the image processing IC shown in FIGS. 6 and 7 during the broadcast reception finish processing.

FIG. 13 is a flow diagram of an operation example of an image decoder.

FIG. 14 is a view illustrative of the operation of the image decoder of the image processing IC shown in FIGS. 6 and 7.

FIG. 15 is a flow diagram of an operation example of a sound decoder.

FIG. 16 is a view illustrative of the operation of the image decoder of the image processing IC shown in FIGS. 6 and 7.

FIG. 17 is a flow diagram of a processing example of the host CPU when generating MP4 data, 3GP data or 3G2 data.

FIG. 18 is a view illustrative of the operation of the image processing IC when recording MP4 data, 3GP data or 3G2 data.

FIG. 19 is a flow diagram of a processing example of the host CPU when generating AAC data.

FIG. 20 is a view illustrative of the operation of the image processing IC when recording AAC data.

FIG. 21 is a flow diagram of a processing example of the host CPU when generating compressed still image data.

FIG. 22 is a view illustrative of the operation of the image processing IC when recording compressed still image data.

### DETAILED DESCRIPTION OF THE EMBODIMENT

The configuration disclosed in JP-A-8-130745 has a problem in which the processing is fixed and an increase in the circuit scale increases cost. In particular, when employing the configuration disclosed in JP-A-8-130745 for each complicated processing such as receiving and reproducing one-segment broadcasting, it is difficult to mount such a configuration on a portable terminal.

A configuration may also be employed in which a multimedia processing central processing unit (CPU) which decodes an image and sound is provided in addition to a telephone CPU which performs processing which realizes a telephone function of a portable telephone so that the multimedia processing CPU achieves additional functions.

However, taking the bit rate of one-segment broadcasting into consideration, most of the band for one-segment broadcasting is utilized for image data and sound data so that the band of data broadcasting becomes narrow. The processing realized using the multimedia processing CPU may be achieved by merely reproducing image data and sound data. Nevertheless, the configuration employing the multimedia processing CPU requires that the multimedia processing CPU always operate, whereby power consumption is increased.

Specifically, a high processing performance is required while reducing the circuit scale and power consumption, taking mounting on a portable terminal into consideration.

Moreover, it is desirable that image data and sound data of one-segment broadcasting be recorded in a portable terminal at low power consumption.

According to the following embodiments, an information recording device and an electronic instrument can be provided capable of recording multiplexed image data and sound data according to various standards with a reduced circuit scale and power consumption.

According to one embodiment of the invention, there is provided an information recording device for recording data included in a transport stream, the information recording device comprising:

a separation section which extracts a first transport stream (TS) packet for generating image data as reproduction data, a second TS packet for generating sound data as reproduction data, and a third TS packet other than the first and second TS packets from the transport stream; and

a memory including a first memory area in which the first TS packet is stored, a second-memory area in which the second TS packet is stored, and a third memory area in which the third TS packet is stored;

the separation section extracting the first and second TS packets based on analysis results of the third TS packet extracted from the transport stream; and

the first and second TS packets read from the first and second memory areas being multiplexed and generated as Moving Picture Experts Group phase 4 data, 3rd Generation Partnership Project data or 3rd Generation Partnership Project 2 data (MP4 data, 3GP data or 3G2 data).

According to this embodiment, even if various packets are transmitted as a TS in a multiplexed state such as in digital terrestrial broadcasting, the first and second TS packets are extracted from the TS after classifying the third packet. The first and second TS packets are then read from the memory to generate MP4 data, 3GP data or 3G2 data. Therefore, even if the packets are transmitted as the TS, the MP4 data, the 3GP data or the 3G2 data can be recorded without increasing the processing load.

According to another embodiment of the invention, there is provided an information recording device for recording data included in a transport stream, the information recording device comprising:

a separation section which extracts a first transport stream (TS) packet for generating image data as reproduction data, a second TS packet for generating sound data as reproduction data, and a third TS packet other than the first and second TS packets from the transport stream; and

a memory including a first memory area in which the first TS packet is stored, a second memory area in which the second TS packet is stored, and a third memory area in which the third TS packet is stored;

the separation section extracting the first and second TS packets based on analysis results of the third TS packet extracted from the transport stream; and

the second TS packet read from the second memory area being generated as Moving Picture Experts Group Phase 2 Advanced Audio Coding (MPEG-2 AAC) data.

According to this embodiment, even if various packets are transmitted as a TS in a multiplexed state such as in digital terrestrial broadcasting, the first and second TS packets are extracted from the TS after classifying the third packet. The second TS packet is then read from the memory to generate AAC data. Therefore, even if the packets are transmitted as the TS, the AAC data can be recorded without increasing the processing load.

According a further embodiment of the invention, there is provided an information recording device for recording data included in a transport stream, the information recording device comprising:

a separation section which extracts a first transport stream (TS) packet for generating image data as reproduction data, a second TS packet for generating sound data as reproduction data, and a third TS packet other than the first and second TS packets from the transport stream;

a memory including a first memory area in which the first TS packet is stored, a second memory area in which the second TS packet is stored, and a third memory area in which the third TS packet is stored; and

an image decoder which performs image decoding which generates image data based on the first TS packet read from the first memory area;

the separation section extracting the first and second TS packets based on analysis results of the third TS packet extracted from the transport stream; and

compressed still image data being generated based on the image data generated by the image decoder.

According to this embodiment, even if various packets are transmitted as a TS in a multiplexed state such as in digital terrestrial broadcasting, the first and second TS packets are extracted from the TS after classifying the third packet. The image decoder then decodes the first TS packet to generate image data, and compressed still image data is generated based on the image data. Therefore, even if the packets are transmitted as the TS, the compressed still image data can be recorded without increasing the processing load.

In the information recording device according to this embodiment,

the memory may include a fourth memory area in which image elementary stream (ES) data is stored, the image ES data being obtained by deleting a packetized elementary stream (PES) header from a first PES packet generated using the first TS packet; and

the image decoder may delete the PES header from the first PES packet, may store the image ES data in the fourth memory area, and may perform the image decoding based on the image ES data read from the fourth memory area.

For example, taking the bit rate of one-segment broadcasting into consideration, most of the band for one-segment broadcasting is utilized for image data and sound data so that the band of data broadcasting becomes narrow. According to this embodiment, the image decoder which exclusively decodes data is provided instead of a high-performance CPU which consumes a large amount of power, and a low-performance decoder can be utilized as the image decoder. Moreover, image data reproduction processing can be realized at low power consumption in addition to the above record processing.

The information recording device according to this embodiment may comprise:

a sound decoder which performs sound decoding which generates sound data based on the second TS packet read from the second memory area.

In the information recording device according to this embodiment,

the memory may include a fifth memory area in which sound elementary stream (ES) data is stored, the sound ES data being obtained by deleting a packetized elementary stream (PES) header from a second PES packet generated using the second TS packet; and

the sound decoder may delete the PES header from the second PES packet, may store the sound ES data in the fifth memory area, and may perform the sound decoding based on the sound ES data read from the fifth memory area.

In the information recording device according this embodiment,

the image decoder may read the first TS packet from the first memory area independently of the sound decoder, and may perform the image decoding based on the first TS packet; and

the sound decoder may read the second TS packet from the second memory area independently of the image decoder, and may perform the sound decoding based on the second TS packet.

According to a further embodiment of the invention, there is provided an information recording device for recording data included in a transport stream, the information recording device comprising:

a memory including a sixth memory area in which TS data including a first transport stream (TS) packet for generating image data as reproduction data, a second TS packet for generating sound data as reproduction data, and a third TS packet other than the first and second TS packets is stored, the information recording device directly generating the TS data read from the sixth the memory area.

According to one of the above embodiments, the image decoder and the sound decoder which independently decode data are provided instead of a high-performance CPU which consumes a large amount of power, and low-performance decoders can be utilized as the image decoder and the sound decoder. Therefore, power consumption can be flexibility reduced by appropriately suspending the operation of one of the image decoder and the sound decoder, whereby the power consumption of the information reproduction device which performs heavy-load one-segment broadcasting record processing and reproduction processing can be reduced.

Furthermore, since the image decoder and the sound decoder can be operated in parallel, it suffices that each decoder exhibit low performance, whereby power consumption and cost can be further reduced.

According to a further embodiment of the invention, there is provided an electronic instrument comprising:

one of the above information recording devices; and

a host which analyzes the third TS packet extracted from the transport stream, and generates the AAC data, the MPEG-2 AAC data, or the compressed data.

According to a further embodiment of the invention, there is provided an electronic instrument comprising:
a tuner;
one of the above information recording devices to which a transport stream from the tuner is supplied; and
a host which analyzes the third TS packet extracted from the transport stream, and generates the AAC data, the MPEG-2 AAC data, or the compressed data.

According to the above embodiment, an electronic instrument can be provided capable of recording multiplexed image data and sound data according to various standards with a reduced circuit scale and power consumption.

The embodiments are described below in detail with reference to the drawings. Note that the embodiments given below do not in any way limit the scope of the invention laid out in the claims. Note that all of the elements of the embodiments given below should not necessarily be taken as essential requirements for the invention.

1. Summary of One-Segment Broadcasting

Digital terrestrial broadcasting introduced to replace analog terrestrial broadcasting is expected to provide various new services in addition to increasing the image and sound quality.

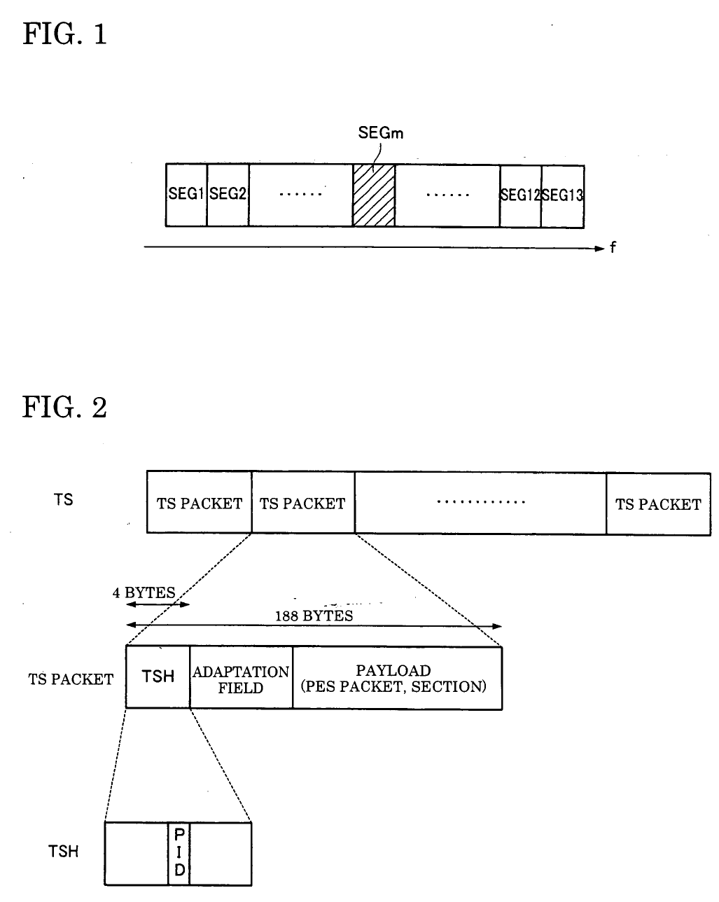

FIG. 1 is a view illustrative of the concept of segments of digital terrestrial broadcasting.

In digital terrestrial broadcasting, a frequency band assigned in advance is divided into 14 segments, and a program is broadcast utilizing 13 segments SEG1 to SEG13 among the 14 segments. The remaining one segment is used as a guard band. One segment SEGm among the 13 segments used to broadcast a program is assigned to the frequency band for broadcasting for portable terminals.

In one-segment broadcasting, a transport stream (TS) is transmitted in which encoded (compressed) image data, sound data, and other types of data (control data) are multiplexed. In more detail, after the addition of a Reed-Solomon error correction code to each packet of the TS, each packet is hierarchically separated, and each layer is subjected to convolutional coding and carrier modulation. After layer synthesis, frequency interleaving and time interleaving are performed. A pilot signal necessary for the receiver is then added to form an OFDM segment frame. The OFDM segment frame is subjected to inverse Fourier transform calculation and is transmitted as an OFDM signal.

FIG. 2 is a view illustrative of a TS.

As shown in FIG. 2, a TS includes a plurality of TS packets. The length of each TS packet is set at 188 bytes. Each TS packet is provided with 4-byte header information called a TS header (TSH), and includes a packet identifier (PID) which is the identifier of the TS packet. A program of one-segment broadcasting is specified by the PID.

The TS packet includes an adaptation field, in which a program clock reference (PCR), which is time information serving as a reference for synchronous reproduction of image data and sound data, and dummy data are provided. A payload includes data for generating a packetized elementary stream (PES) packet and a section.

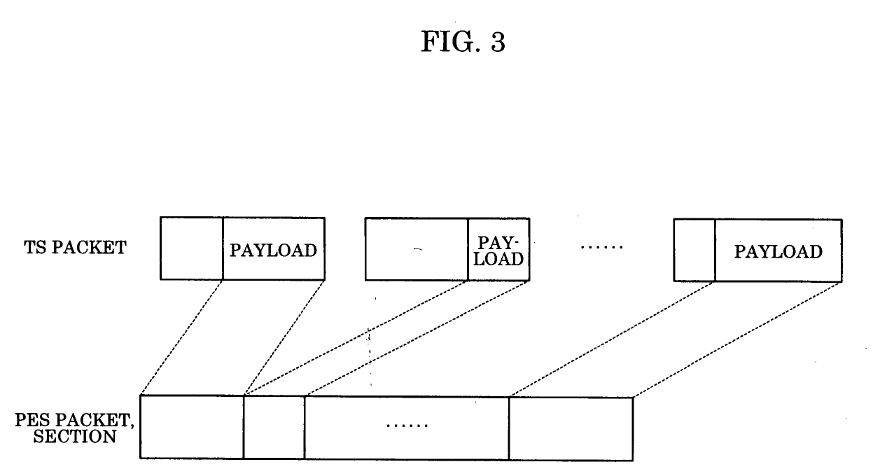

FIG. 3 is a view illustrative of the PES packet and the section.

The PES packet and the section are respectively formed of the payload of each of one or more TS packets. The PES packet includes a PES header and a payload. Image data, sound data, or subtitle data is set in the payload as elementary stream (ES) data. Program information of image data or the like set in the PES packet is set in the section.

Therefore, when a TS has been received, it is necessary to analyze the program information included in the section and specify the PID corresponding to the broadcast program. Image data and sound data corresponding to the PID are extracted from the TS, and the extracted image data and sound data are reproduced.

2. Portable Terminal

A portable terminal having a one-segment broadcasting receiving function must perform processing such as the above-described packet analysis. Specifically, such a portable terminal is required to exhibit high performance. Therefore, when adding a one-segment broadcasting receiving function to an ordinary portable telephone as a portable terminal (electronic instrument in a broad sense), it is necessary to additionally provide a high-performance processor or the like.

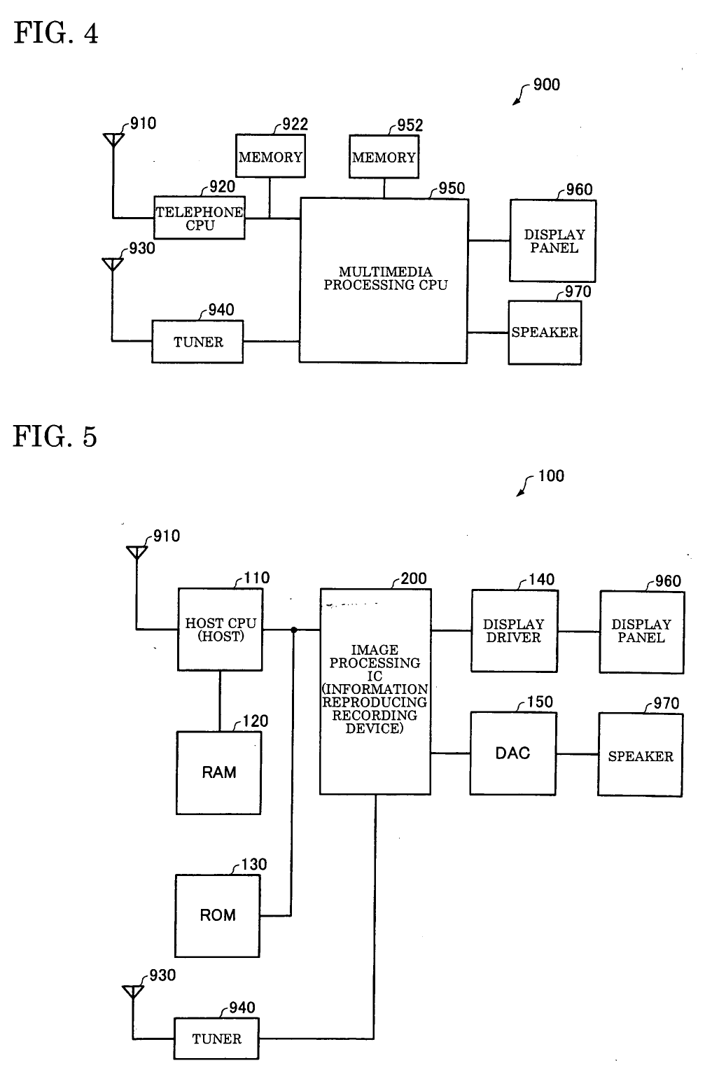

FIG. 4 is a block diagram of a configuration example of a portable telephone including a multimedia processing CPU according to a comparative example of this embodiment.

In a portable telephone 900, a telephone CPU 920 performs call-in processing by demodulating a signal received through an antenna 910, and a signal subjected to call-out processing by the telephone CPU 920 is modulated and transmitted through the antenna 910. The telephone CPU 920 performs the call-in processing and the call-out processing by reading a program stored in a memory 922.

When a desired signal is extracted through a tuner 940 from a signal received through an antenna 930, a TS is generated in the reverse of the above-mentioned order using the desired signal as an OFDM signal. A multimedia processing CPU 950 analyzes TS packets from the generated TS to determine the PES packet and the section, and decodes image data and sound data from the TS packet of the desired program. The multimedia processing CPU 950 performs the above packet analysis and decoding by reading a program stored in a memory 952. A display panel 960 displays an image based on the decoded image data. A speaker 970 outputs sound based on the decoded sound data.

As described above, the multimedia processing CPU 950 is required to exhibit extremely high performance. A high-performance processor generally requires a high operating frequency and a large circuit scale.

On the other hand, taking the bit rate of one-segment broadcasting into consideration, most of the band for one-segment broadcasting is utilized for image data and sound data so that the band of data broadcasting becomes narrow. Therefore, even if the processing realized by the multimedia processing CPU may be achieved by merely reproducing image data and sound data, it is necessary to always operate the multimedia processing CPU, whereby power consumption is increased.

According to this embodiment, an image decoder which decodes image data and a sound decoder which decodes sound data are independently provided and caused to decode data independently so that low-performance decoders can be utilized as the image decoder and the sound decoder. Moreover, power consumption can be flexibility reduced by appropriately suspending the operation of one of the image decoder and the sound decoder.

Furthermore, since the image decoder and the sound decoder can be operated in parallel, it suffices that each decoder exhibit low performance, whereby power consumption and cost can be further reduced.

FIG. 5 is a block diagram of a configuration example of a portable telephone including an information reproducing recording device according to this embodiment. In FIG. 5, the same sections as in FIG. 4 are indicated by the same symbols. Description of these sections is appropriately omitted.

A portable telephone 100 may include a host CPU (host in a broad sense) 110, a random access memory (RAM) 120, a read only memory (ROM) 130, a display driver 140, a digital-to-analog converter (DAC) 150, and an image processing integrated circuit (IC) (information reproducing recording device in a broad sense, information recording device in a broader sense) 200. The portable telephone 100 also includes the antennas 910 and 930, the tuner 940, the display panel 960, and the speaker 970.

The host CPU 110 has the function of the telephone CPU 920 shown in FIG. 4 and the function of controlling the image processing IC 200. The host CPU 110 reads a program stored in the RAM 120 or the ROM 130, and performs the processing of the telephone CPU 920 shown in FIG. 4 or controls the image processing IC 200. In this case, the host CPU 110 may utilizes the RAM 120 as a work area.

The image processing IC 200 extracts an image TS packet (first TS packet) for generating image data and a sound TS packet (second TS packet) for generating sound data from a TS from the tuner 940, and buffers the packets in a shared memory (not shown). The image processing IC 200 includes an image decoder and a sound decoder (not shown) of which the operations can be independently suspended. The image decoder and the sound decoder respectively decode the image TS packet and the sound TS packet to generate image data and sound data. The image data and the sound data are respectively supplied to the display driver 140 and the DAC 150 in synchronization. The host CPU 110 directs the image processing IC 200 to start image decoding and sound decoding. The host CPU 110 may direct the image processing IC 200 to start at least one of image decoding and sound decoding.

The display driver (driver circuit in a broad sense) 140 drives the display panel (electro-optical device in a broad sense) 960 based on the image data. In more detail, the display panel 960 includes a plurality of scan lines, a plurality of data lines, and a plurality of pixels each of which is specified by the scan line and the data line. A liquid crystal display panel may be utilized as the display panel 960. The display driver 140 has a function of a scan driver which scans the scan lines and a function of a data driver which drives the data lines based on the image data.

The DAC 150 converts sound data (digital signal) into an analog signal, and supplies the analog signal to the speaker 970. The speaker 970 outputs sound corresponding to the analog signal from the DAC 150.

3. Information Reproducing Recording Device

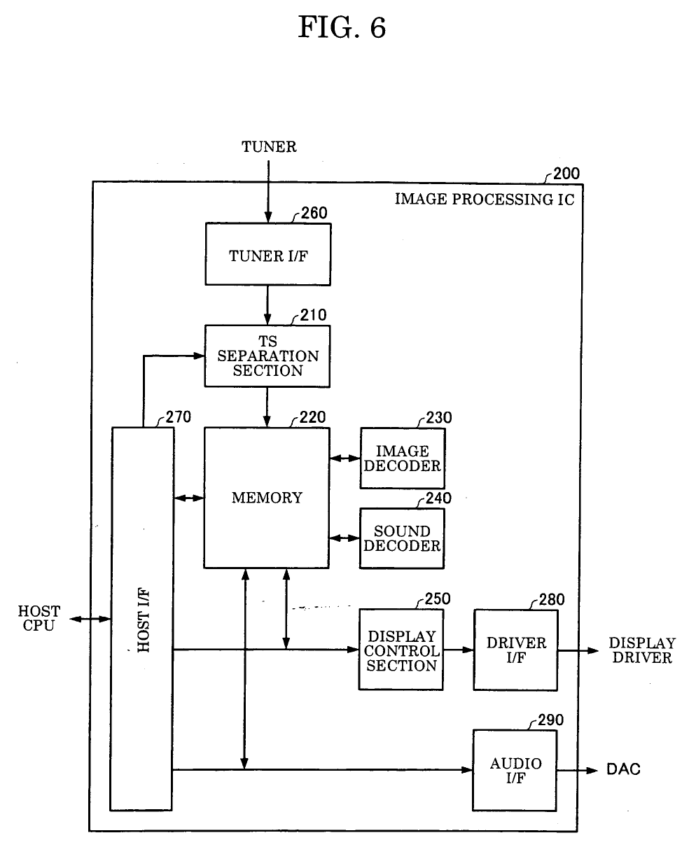

FIG. 6 is a block diagram of a configuration example of the image processing IC 200 shown in FIG. 5 as the information reproducing recording device according to this embodiment.

The image processing IC 200 includes a TS separation section (separation section) 210, a memory (shared memory) 220, an image decoder 230, and a sound decoder 240. The image processing IC 200 also includes a display control section 250, a tuner interface (I/F) 260, a host I/F 270, a driver I/F 280, and an audio I/F 290.

The TS separation section 210 extracts an image TS packet (first TS packet) for generating image data, a sound TS packet (second TS packet) for generating sound data, and a packet (third TS packet) other than the image TS packet and the sound TS packet from a TS. The TS separation section 210 may extract the first and second TS packets based on analysis results from the host CPU 110 which analyzes the third TS packet extracted from the TS.

The memory 220 includes a plurality of memory areas. The head address and the end address of each memory area are determined in advance. The image TS packet, the sound TS packet, and the TS packet other than the image TS packet and the sound TS packet separated by the TS separation section 210 are stored in the memory areas exclusively provided for the respective TS packets.

The image decoder 230 reads the image TS packet from the memory area of the memory 220 exclusively provided for the image TS packet, and performs image decoding which generates image data based on the image TS packet.

The sound decoder 240 reads the sound TS packet from the memory area of the memory 220 exclusively provided for the sound TS packet, and performs sound decoding which generates sound data based on the sound TS packet.

The display control section 250 performs rotation processing which rotates the orientation of the image represented by the image data read from the memory 220, or resize processing which reduces or increases the size of the image. The rotated data or the resized data is supplied to the driver I/F 280.

The tuner I/F 260 performs interface processing between the image processing IC 200 and the tuner 940. In more detail, the tuner I/F 260 receives a TS from the tuner 940. The tuner I/F 260 is connected with the TS separation section 210.

The host I/F 270 performs interface processing between the image processing IC 200 and the host CPU 110. In more detail, the host I/F 270 controls data transmission between the image processing IC 200 and the host CPU 110. The host I/F 270 is connected with the TS separation section 210, the memory 220, the display control section 250, and the audio I/F 290.

The driver I/F 280 reads image data from the memory 220 through the display control section 250 in a specific cycle, and supplies the image data to the display driver 140. The driver I/F 280 performs interface processing for transmitting image data to the display driver 140.

The audio I/F 290 reads sound data from the memory 220 in a specific cycle, and supplies the sound data to the DAC 150. The audio I/F 290 performs interface processing for transmitting sound data to the DAC 150.

In the image processing IC 200, the TS separation section 210 extracts TS packets from a TS from the tuner 940. The TS packet is stored in the memory area of the memory 220 (shared memory) assigned in advance. The image decoder 230 and the sound decoder 240 respectively read the TS packets from the exclusive memory areas assigned in the memory 220 to generate image data and sound data, and supply the image data and the sound data in synchronization to the display driver 140 and the DAC 150.

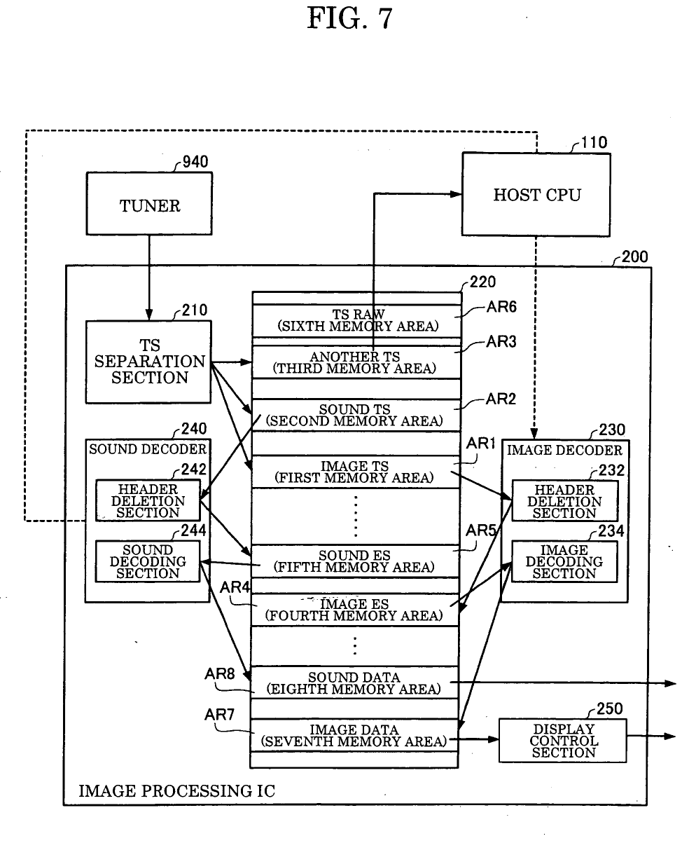

FIG. 7 is a view illustrative of the operation of the image processing IC 200 shown in FIG. 6.

In FIG. 7, the same sections as in FIG. 6 are indicated by the same symbols. Description of these sections is appropriately omitted.

The memory 220 includes first to eighth memory areas AR1 to AR8. Each memory area is assigned in advance.

An image TS packet (first TS packet) extracted by the TS separation section 210 is stored in the first memory area AR1 as an exclusive memory area for the image TS packet. A sound TS packet (second TS packet) extracted by the TS separation section 210 is stored in the second memory area AR2 as an exclusive memory area for the sound TS packet. A TS packet (third TS packet) extracted by the TS separation section 210 other than the image TS packet and the sound TS packet is stored in the third memory area AR3.

Image ES data generated by the image decoder 230 is stored in the fourth memory area AR4 as an exclusive memory area for the image ES data. Sound ES data generated by the sound decoder 240 is stored in the fifth memory area AR5 as an exclusive memory area for the sound ES data.

A TS generated by the host CPU 110 or a TS input from the tuner 940 without passing through the TS separation section 210 is stored in the sixth memory area AR6 as TS RAW data. The TS RAW data is set by the host CPU 110 instead of a TS from the tuner 940. The TS separation section 210 extracts an image TS packet, a sound TS packet, and a TS packet other than the image TS packet and the sound TS packet from the TS set as the TS RAW data.

Image data decoded by the image decoder 230 is stored in the seventh memory area AR7. The image data stored in the seventh memory area AR7 is read by the display control section 250, and output as an image on the display panel 960. Sound data decoded by the sound decoder 240 is stored in the eighth memory area AR8. The sound data stored in the eighth memory area AR8 is output as sound from the speaker 970.

The image decoder 230 includes a header deletion section 232 and an image decoding section 234. The header deletion section 232 reads the image TS packet from the first memory area AR1, analyzes the TS header of the image TS packet to generate a PES packet (first PES packet), deletes the PES header of the PES packet, and stores the payload of the PES packet in the fourth memory area AR4 of the memory 220 as image ES data. The image decoding section 234 reads the image ES data from the fourth memory area AR4, decodes the image ES data according to the H.264/Advanced Video Coding (AVC) standard (image decoding in a broad sense), and writes the generated image data into the seventh memory area AR7.

The sound decoder 240 includes a header deletion section 242 and a sound decoding section 244. The header deletion section 242 reads the sound TS packet from the second memory area AR2, analyzes the TS header of the sound TS packet to generate a PES packet (second PES packet), deletes the PES header of the PES packet, and stores the payload of the PES packet in the fifth memory area AR5 of the memory 220 as sound ES data. The sound decoding section 244 reads the sound ES data from the fifth memory area AR5, decodes the sound ES data according to the MPEG-2 Advanced Audio Coding (AAC) standard (sound decoding in a broad sense), and writes the generated sound data into the eighth memory area AR8.

The image decoder 230 reads the image TS packet (first TS packet) from the first memory area AR1 independently of the sound decoder 240, and performs the above-mentioned image decoding based on the image TS packet. The sound decoder 240 reads the sound TS packet (second TS packet) from the second memory area AR2 independently of the image decoder 230, and performs the above-mentioned sound decoding based on the sound TS packet. This allows the image decoder 230 and the sound decoder 240 to operate when outputting an image and sound in synchronization, and allows only the image decoder 230 to operate while suspending the operation of the sound decoder 240 when outputting only an image. When outputting only sound, only the sound decoder 240 is allowed to operate while suspending the operation of the image decoder 230.

The host CPU 110 reads another TS packet (third TS packet) stored in the third memory area AR3, and generates a section from the TS packet. The host CPU 110 analyzes various types of table information included in the section. The host CPU 110 sets the analysis results in a specific memory area of the memory 220, and sets the analysis results in the TS separation section 210 as control information. The TS separation section 210 then extracts TS packets from a TS from the tuner 940 according to the control information. Therefore, the TS separation section 210 can extract the first and second TS packets from the TS based on the analysis results from the host CPU 110 which analyzes the third TS packet extracted from the TS from the tuner 940.

The host CPU 110 separately issues start commands to the image decoder 230 and the sound decoder 240. The image decoder 230 and the sound decoder 240 independently access the memory 220, read the analysis results from the host CPU 110, and perform decoding corresponding to the analysis results.

3.1 Reproduction Operation

The operation of the image processing IC 200 as the information reproducing recording device according to this embodiment when reproducing image data or sound data multiplexed in a TS is described below.

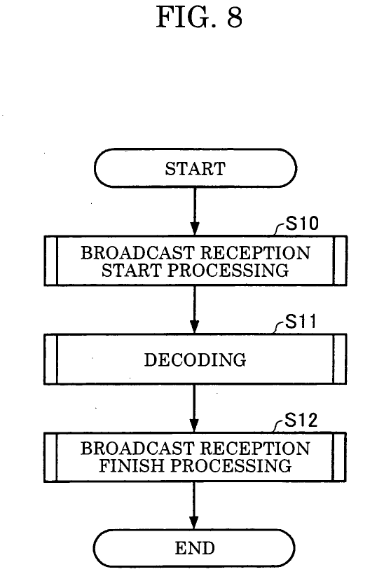

FIG. 8 is a flow diagram of an operation example of reproduction processing of the host CPU 110. The host CPU 110 performs the processing shown in FIG. 8 by reading a program stored in the RAM 120 or the ROM 130 and performs processing corresponding to the program.

The host CPU 110 performs broadcast reception start processing (step S10). This allows image data or sound data of a desired program among a plurality of programs received as a TS to be extracted from the TS. The host CPU 110 activates at least one of the image decoder 230 and the sound decoder 240 of the image processing IC 200.

The host CPU 110 causes the image decoder 230 and the sound decoder 240 to perform decoding when reproducing an image and sound. When reproducing only an image, the host CPU 110 causes the image decoder 230 to perform decoding while suspending the operation of the sound decoder 240. When reproducing only sound, the host CPU 110 causes the sound decoder 240 to perform decoding while suspending the operation of the image decoder 230 (step S11).

The host CPU 110 then performs broadcast reception finish processing (step S12), and finish the processing (END). The host CPU 110 thus suspends the operation of each section of the image processing IC 200.

3.1.1 Broadcast Reception Start Processing

A processing example of the broadcast reception start processing shown in FIG. 8 is described below. This examples illustrates the case of reproducing an image and sound.

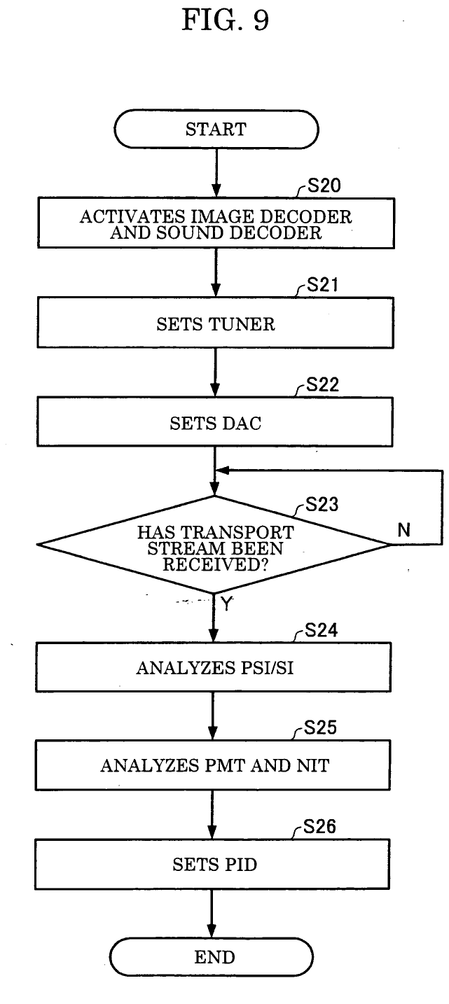

FIG. 9 is a flow diagram of an operation example of the broadcast reception start processing shown in FIG. 8. The host CPU 110 performs the processing shown in FIG. 9 by reading a program stored in the RAM 120 or the ROM 130 and performs processing corresponding to the program.

The host CPU 110 activates the image decoder 230 and the sound decoder 240 of the image processing IC 200 (step S20). The host CPU 110 initializes the tuner 940 and sets given operation information (step S21). The host CPU 110 also initializes the DAC 150 and sets given operation information (step S22).

The host CPU 110 then monitors reception of a TS (step S23: N). When reception of a TS has commenced, the TS separation section 210 of the image processing IC 200 separates an image TS packet, a sound TS packet, and a TS packet other than the image TS packet and the sound TS packet from the TS, and the separated TS packets are stored in the exclusive memory areas of the memory 220, as described above. For example, the host CPU 110 may detect reception of a TS using an interrupt signal generated on condition that a TS packet has been stored in the third memory area AR3 of the memory 220 of the image processing IC 200. The host CPU 110 may determine whether or not a TS packet has been written by periodically accessing the third memory area AR3 of the memory 220 to determine reception of a TS.

When reception of a TS has been detected (step S23: Y), the host CPU 110 reads the TS packet stored in the third memory area AR3 and generates a section. The host CPU 110 analyzes program specific information (PSI)/service information (SI) included in the section (step S24). The PSI/SI is specified by the MPEG-2 Systems (ISO/IEC 13818-1).

The PSI/SI includes a network information table (NIT) and a program map table (PMT). The NIT includes a network identifier for specifying the broadcasting station from which the TS is transmitted, a service identifier for specifying the PMT, a service type identifier indicating the type of broadcasting, and the like. The PID of the image TS packet and the PID of the sound TS packet multiplexed in the TS are set in the PMT, for example.

The host CPU 110 extracts the service identifier for specifying the PMT from the PSI/SI, and specifies the PIDs of the image TS packet and the sound TS packet of the received TS based on the service identifier (step S25). The host CPU 110 sets the PID corresponding to the program selected by the user of the portable terminal or the PID corresponding to the program determined in advance in a specific memory area (e.g. third memory area AR3) of the memory 220 so that the image decoder 230 and the sound decoder 240 can refer to the PID (step S26), and finishes the processing (END).

This allows the image decoder 230 and the sound decoder 240 to decode the image TS packet and the sound TS packet while referring to the PID set in the memory 220.

The host CPU 110 sets information corresponding to the service identifier for specifying the PMT in the TS separation section 210 of the image processing IC 200, for example. The TS separation section 210 determines the section periodically received at specific time intervals, analyzes the PMT corresponding to the above service identifier, extracts an image TS packet and a sound TS packet specified by the PMT and a TS packet other than the image TS packet and the sound TS packet, and stores the packets in the memory 220.

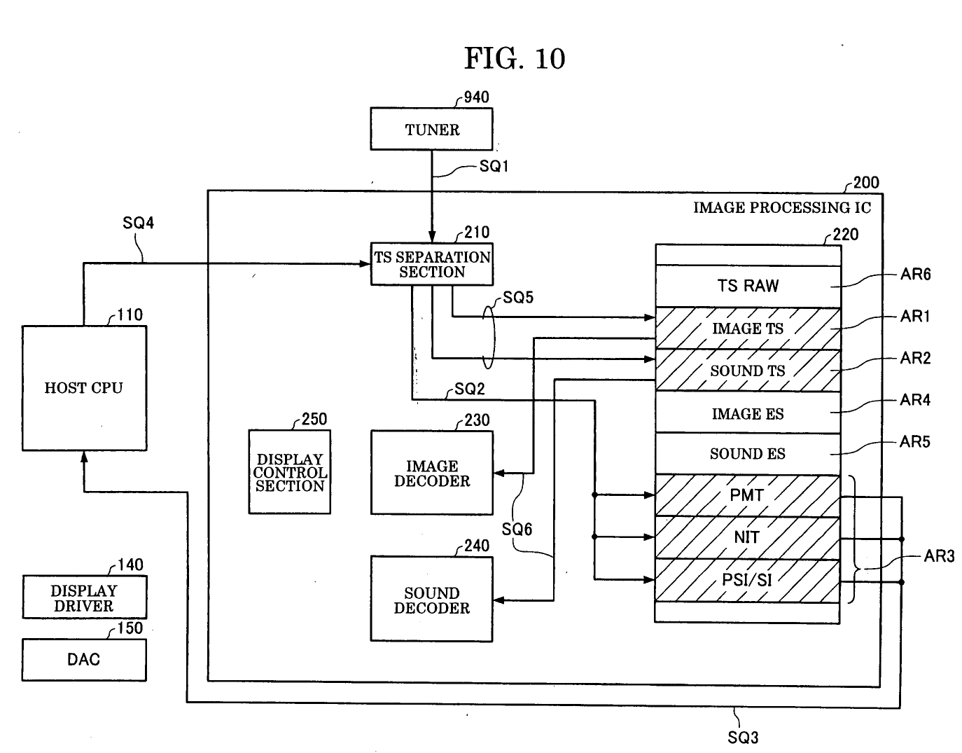

FIG. 10 is a view illustrative of the operation of the image processing IC 200 shown in FIGS. 6 and 7 during the broadcast reception start processing. In FIG. 10, the same sections as in FIG. 6 or 7 are indicated by the same symbols. Description of these sections is appropriately omitted.

In FIG. 10, the fourth memory area AR4 is also used as the seventh memory area AR7, and the fifth memory area AR5 is also used as the eighth memory area AR8. The PSI/SI, NIT, and PMT are stored in specific memory areas in the third memory area AR3.

When a TS has been input from the tuner 940 (SQ1), the TS separation section 210 stores a TS packet including PSI/SI in the memory 220 (SQ2). In this case, the TS separation section 210 may extract the PSI/SI of the TS packet and store the PSI/SI in the memory 220. The TS separation section 210 may extract an NIT from the PSI/SI and store the NIT in the memory 220.

The host CPU 110 reads the PSI/SI, NIT, and PMT (SQ3), analyzes the PSI/SI, NIT, and PMT, and specifies the PID corresponding to the decode target program. The host CPU 110 sets the PID corresponding to the information corresponding to the service identifier or the decode target program in the TS separation section 210 (SQ4). The host CPU 110 also sets the PID in a specific memory area of the memory 220 so that the image decoder 230 and the sound decoder 240 can refer to the PID during decoding.

The TS separation section 210 extracts the image TS packet and the sound TS packet from the TS based on the set PID, and writes the image TS packet and the sound TS packet into the first and second memory areas AR1 and AR2, respectively (SQ5).

The image decoder 230 and the sound decoder 240 activated by the host CPU 110 sequentially read the image TS packet and the sound TS packet from the first and second memory areas AR1 and AR2 (SQ6), and perform the image decoding and the sound decoding.

3.1.2 Broadcast Reception Finish Processing

An operation example of the broadcast reception finish processing shown in FIG. 8 is described below. This examples illustrates the case of reproducing an image and sound.

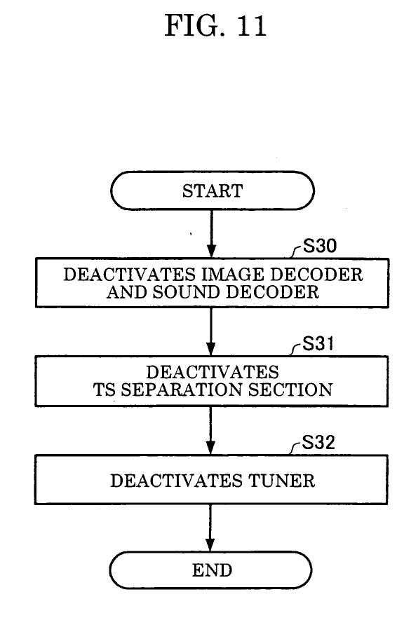

FIG. 11 is a flow diagram of a processing example of the broadcast reception finish processing shown in FIG. 8. The host CPU 110 performs the processing shown in FIG. 11 by reading a program stored in the RAM 120 or the ROM 130 and performs processing corresponding to the program.

The host CPU 110 deactivates the image decoder 230 and the sound decoder 240 of the image processing IC 200 (step S30). For example, the host CPU 110 may issue a control command to the image processing IC 200, and the image processing IC 200 may deactivate the image decoder 230 and the sound decoder 240 using the decode result of the control command.

The host CPU 110 then deactivates the TS separation section 210 (step S31). The host CPU 110 then deactivates the tuner 940 (step S32).

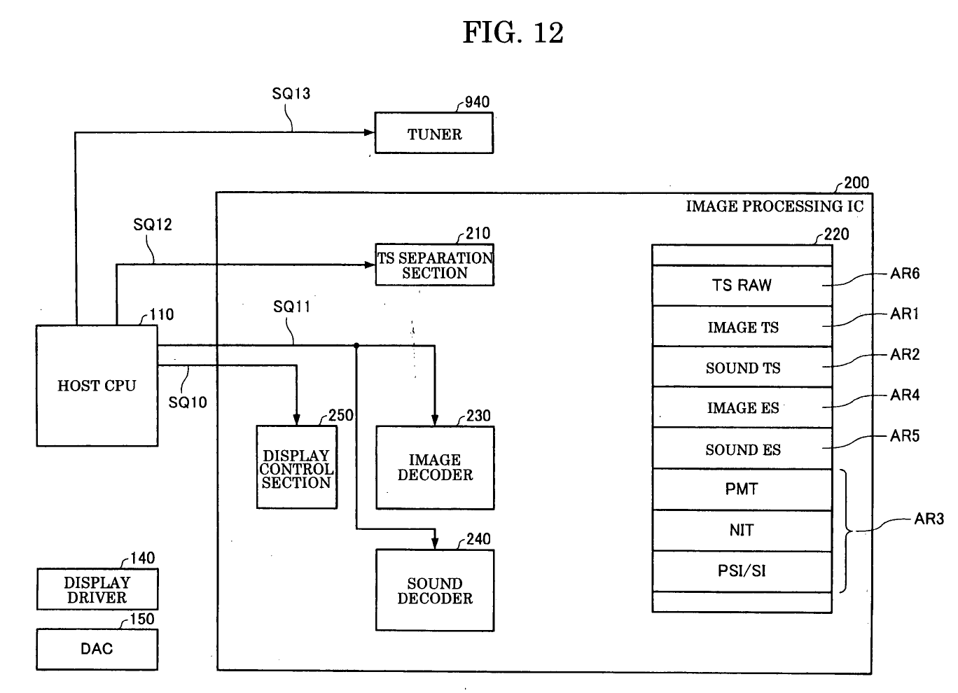

FIG. 12 is a view illustrative of the operation of the image processing IC 200 shown in FIGS. 6 and 7 during the broadcast reception finish processing. In FIG. 12, the same sections as in FIG. 10 are indicated by the same symbols. Description of these sections is appropriately omitted.

The host CPU 10 suspends the operation of the display control section 250 to stop supply of the image data to the display driver 140 (SQ10). The host CPU 110 then suspends the operations of the image decoder 230 and the sound decoder 240 (SQ11), and sequentially suspends the operations of the TS separation section 210 and the tuner 940 (SQ12 and SQ13).

3.1.3 Reproduction Processing

An operation example of the image decoder 230 which reproduces image data is described below.

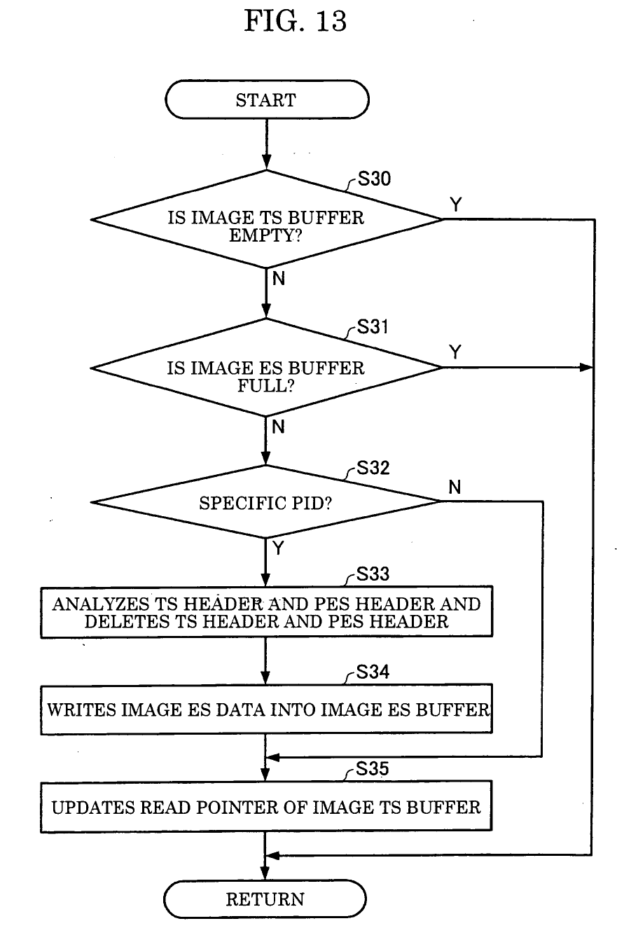

FIG. 13 is a flow diagram of an operation example of the image decoder 230.

When the image decoder 230 has been activated by the host CPU 110, the image decoder 230 reads a program stored in a specific memory area of the memory 220, and performs processing corresponding to the program to perform the processing shown in FIG. 13, for example. Specifically, the image decoder 230 includes a central processing unit (CPU). After initialization of the image processing IC 200 (information reproducing recording device, information recording device), a program for causing the CPU to realize the image decoding is read from the outside of the image processing IC 200, and the CPU realizes the image decoding. Note that the processing of the image decoder 230 may be at least partially performed using hardware such as a combinational circuit or a logic circuit.

At least one of the image decoder 230 and the sound decoder 240 may include a CPU. A program for causing the CPU to realize the decoding may be read from the outside of the image processing IC 200 after initialization of the image processing IC 200.

The image decoder 230 determines whether or not the first memory area AR1 provided as an image TS buffer is empty (step S30). The first memory area AR1 is determined to be empty when the first memory area AR1 does not contain an image TS packet to be read from the first memory area AR1.

When the image decoder 230 has determined that the first memory area AR1 (image TS buffer) is not empty in the step S30 (step S30: N), the image decoder 230 determines whether or not the fourth memory area AR4 provided as an image ES buffer is full (step S31). The fourth memory area AR4 is determined to be full when the image ES data cannot be additionally stored in the fourth memory area AR4.

When the image decoder 230 has determined that the fourth memory area AR4 (image ES buffer) is not full in the step S31 (step S31: N), the image decoder 230 reads the image TS packet from the first memory area AR1, and detects whether or not the PID of the image TS packet is the PID (specific PID) specified by the host CPU 110 in the step S26 in FIG. 9 (step S32).

When the image decoder 230 has detected that the PID of the image TS packet is the specific PID in the step S32 (step S32: Y), the image decoder 230 analyzes the TS header and the PES header (step S33), and stores the image ES data in the fourth memory area AR4 provided as an image ES buffer (step S34).

The image decoder 230 then updates a read pointer for specifying the read address of the first memory area AR1 (image TS buffer) (step S35), and returns to the step S30 (RETURN).

When the image decoder 230 has detected that the PID of the image TS packet is not the specific PID in the step S32 (step S32: N), the processing proceeds to the step S35. When the image decoder 230 has determined that the first memory area AR1 (image TS buffer) is empty in the step S30 (step S30: Y), or when the image decoder 230 has determined that the fourth memory area AR4 (image ES buffer) is full in the step S31 (step S31: Y), the processing returns to the step S30 (RETURN).

The image ES data stored in the fourth memory area AR4 is decoded by the image decoder 230 according to the H.264/AVC standard, and written into the seventh memory area AR7 as image data (see FIG. 7).

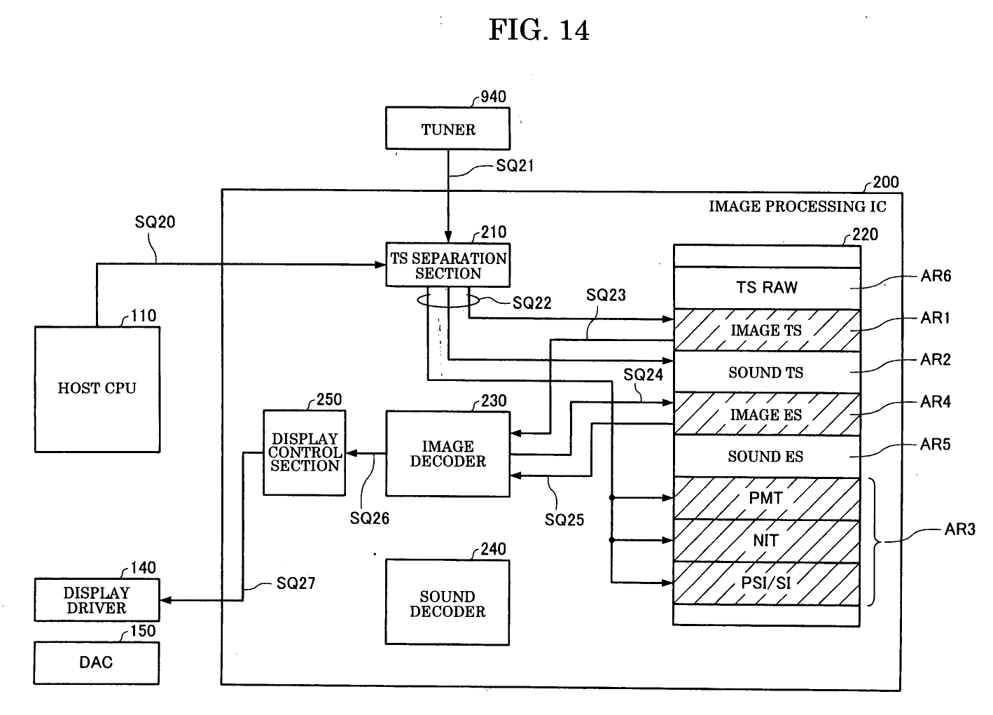

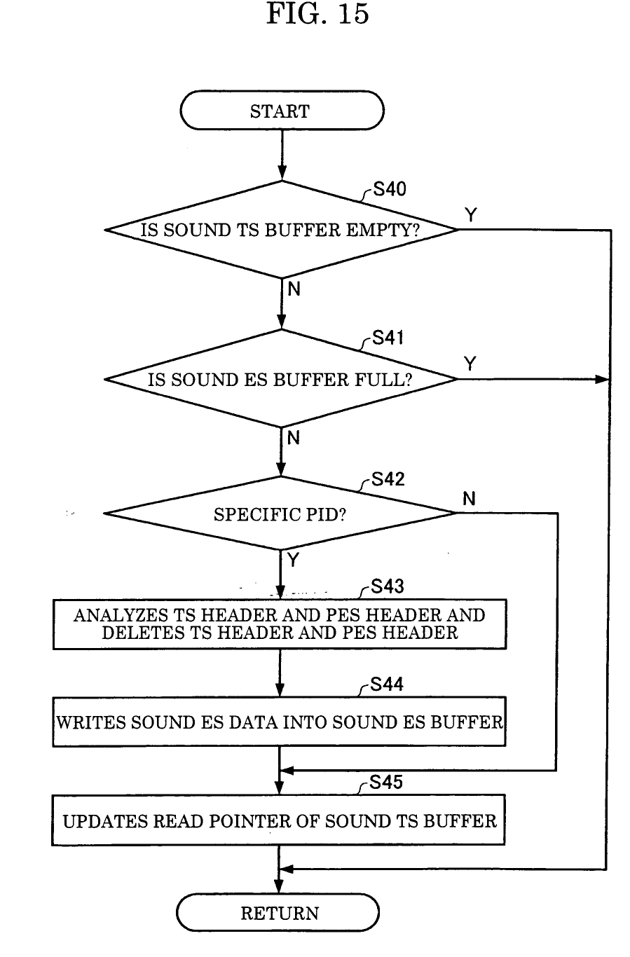

FIG. 14 is a view illustrative of the operation of the image decoder of the image processing IC 200 shown in FIGS. 6 and 7. In FIG. 14, the same sections as in FIG. 10 are indicated by the same symbols. Description of these sections is appropriately omitted.

In FIG. 14, the fourth memory area AR4 is also used as the seventh memory area AR7, and the fifth memory area AR5 is also used as the eighth memory area AR8. The PSI/SI, NIT, and PMT are stored in specific memory areas in the third memory area AR3.

As shown in FIG. 9, the host CPU 110 sets the PID corresponding to the decode target program in the TS separation section 210 (SQ20). When a TS has been input from the tuner 940 (SQ21), the TS separation section 210 separates an image TS packet, a sound TS packet, and a TS packet other than the image TS packet and the sound TS packet from the TS from the tuner 940 (SQ22). The image TS packet separated by the TS separation section 210 is stored in the first memory area AR1. The sound TS packet separated by the TS separation section 210 is stored in the second memory area AR2. The TS packet other than the image TS packet and the sound TS packet separated by the TS separation section 210 is stored in the third memory area AR3 as PSI/SI. In this case, the TS separation section 210 extracts the NIT and the PMT from the PSI/SI and stores the NIT and the PMT in the third memory area AR3.

The image decoder 230 activated by the host CPU 110 reads the image TS packet from the first memory area AR1 (SQ23), generates image ES data, and stores the image ES data in the fourth memory area AR4 (SQ24).

The image decoder 230 reads the image ES data from the fourth memory area AR4 (SQ25), and decodes the image ES data according to the H.264/AVC standard. In FIG. 14, the decoded image data is directly supplied to the display control section 250 (SQ26). Note that it is preferable to write the decoded image data into a specific memory area of the memory 220 provided as a frame buffer and supply the image data to the display control section 250 in synchronization with the output timing of the sound data.

The display driver 140 drives the display panel based on the image data supplied to the display control section 250 (SQ27).

An operation example of the sound decoder 240 which reproduces sound data is described below.

FIG. 15 is a flow diagram of an operation example of the sound decoder 240.

When the sound decoder 240 has been activated by the host CPU 110, the sound decoder 240 reads a program stored in a specific memory area of the memory 220, and performs processing corresponding to the program to perform the processing shown in FIG. 15, for example. Specifically, the sound decoder 240 includes a central processing unit (CPU). After initialization of the image processing IC 200 (information reproducing recording device, information recording device), a program for causing the CPU to realize the sound decoding is read from the outside of the image processing IC 200, and the CPU realizes the sound decoding. Note that the processing of the sound decoder 240 may be at least partially performed using hardware such as a combinational circuit or a logic circuit.

The sound decoder 240 determines whether or not the second memory area AR2 provided as a sound TS buffer is empty (step S40). The second memory area AR2 is determined to be empty when the second memory area AR2 does not contain a sound TS packet to be read from the second memory area AR2.

When the sound decoder 240 has determined that the second memory area AR2 (sound TS buffer) is not empty in the step S40 (step S40: N), the sound decoder 240 determines whether or not the fifth memory area AR5 provided as a sound ES buffer is full (step S41). The fifth memory area AR5 is determined to be full when the sound ES data cannot be additionally stored in the fifth memory area AR5.

When the sound decoder 240 has determined that the fifth memory area AR5 (sound ES buffer) is not full in the step S41 (step S41: N), the sound decoder 240 reads the sound TS packet from the second memory area AR2, and detects whether or not the PID of the sound TS packet is the PID (specific PID) specified by the host CPU 110 in the step S26 in FIG. 9 (step S42).

When the sound decoder 240 has detected that the PID of the sound TS packet is the specific PID in the step S42 (step S42: Y), the sound decoder 240 analyzes the TS header and the PES header (step S43), and stores the sound ES data in the fifth memory area AR5 provided as a sound ES buffer (step S34).

The sound decoder 240 then updates a read pointer for specifying the read address of the second memory area AR2 (sound TS buffer) (step S45), and returns to the step S40 (RETURN).

When the sound decoder 240 has detected that the PID of the sound TS packet is not the specific PID in the step S42 (step S42: N), the processing proceeds to the step S45. When the sound decoder 240 has determined that the second memory area AR2 (sound TS buffer) is empty in the step S40 (step S40: Y), or when the sound decoder 240 has determined that the fifth memory area AR5 (sound ES buffer) is full in the step S41 (step S41: Y), the processing returns to the step S40 (RETURN).

The sound ES data stored in the fifth memory area AR5 is decoded by the sound decoder 240 according to the MPEG-2 AAC standard, and written into the eighth memory area AR8 (see FIG. 7) as sound data.

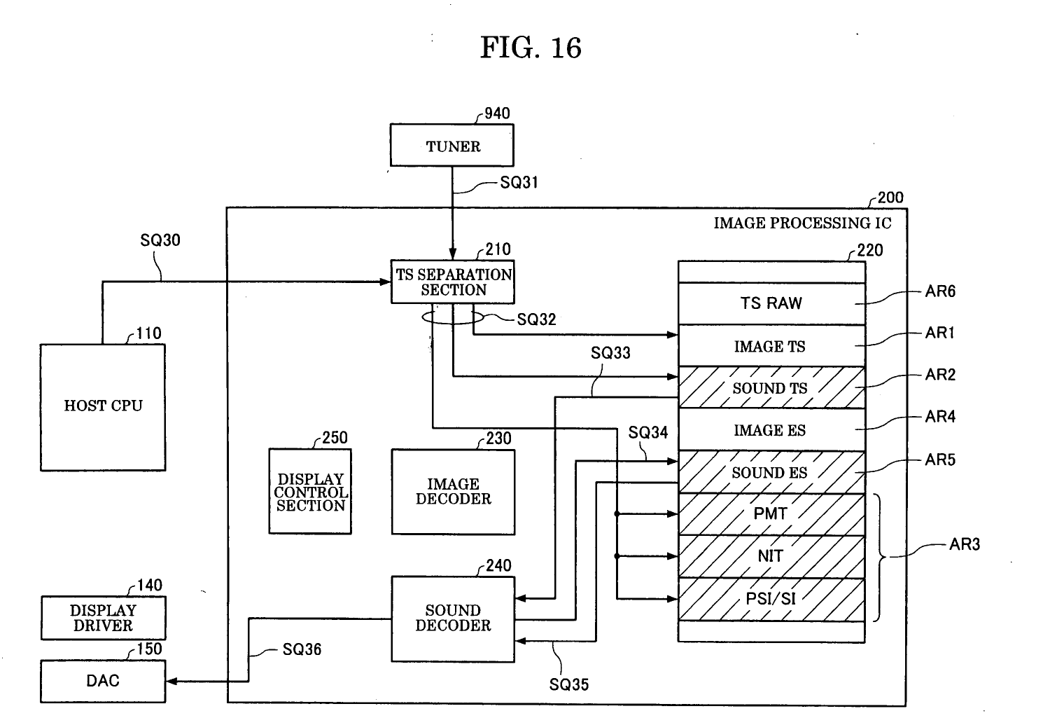

FIG. 16 is a view illustrative of the operation of the image decoder of the image processing IC 200 shown in FIGS. 6 and 7. In FIG. 16, the same sections as in FIG. 10 are indicated by the same symbols. Description of these sections is appropriately omitted.

In FIG. 16, the fourth memory area AR4 is also used as the seventh memory area AR7, and the fifth memory area AR5 is also used as the eighth memory area AR8. The PSI/SI, NIT, and PMT are stored in specific memory areas in the third memory area AR3.

As shown in FIG. 9, the host CPU 110 sets the PID corresponding to the decode target program in the TS separation section 210 (SQ30). When a TS has been input from the tuner 940 (SQ31), the TS separation section 210 separates an image TS packet, a sound TS packet, and a TS packet other than the image TS packet and the sound TS packet from the TS from the tuner 940 (SQ32). The image TS packet separated by the TS separation section 210 is stored in the first memory area AR1. The sound TS packet separated by the TS separation section 210 is stored in the second memory area AR2. The TS packet other than the image TS packet and the sound TS packet separated by the TS separation section 210 is stored in the third memory area AR3 as PSI/SI. The TS separation section 210 extracts the NIT and the PMT from the PSI/SI, and writes the NIT and the PMT into the third memory area AR3.

The sound decoder 240 activated by the host CPU 110 reads the sound TS packet from the second memory area AR2 (SQ33), generates sound ES data, and stores the sound ES data in the fifth memory area AR5 (SQ34).

The sound decoder 240 then reads the sound ES data from the fifth memory area AR5 (SQ35), and decodes the sound ES data according to the MPEG-2 AAC standard. In FIG. 16, the decoded sound data is directly supplied to the DAC 150 (SQ36). Note that it is preferable to write the decoded sound data into a specific memory area of the memory 220 and supply the sound data to the DAC 150 in synchronization with the output timing of the image data.

The sound decoder 240 is operated independently of the operation of the image decoder 230.

3.2 Record Processing

The image processing IC 200 according to this embodiment may record image data and sound data included in a TS from the tuner 940 in addition to reproducing image data and sound data based on TS packets separated from a TS from the tuner 940 as described above. For example, the image processing IC 200 may have various recording modes, and perform specific record processing in each recording mode.

3.2.1 Recording MP4 Data, 3GP Data or 3G2 Data

Moving Picture Experts Group phase 4 data, 3rd Generation Partnership Project data or 3rd Generation Partnership Project 2 data (MP4 data, 3GP data or 3G2 data) is data in which H.264/AVC data (image data) and MPEG-2 Advanced Audio Coding (AAC) data (sound data) are multiplexed. In this case, the TS separation section 210 extracts first and second TS packets based on analysis results from the host CPU 110 which analyzes a third TS packet extracted from a TS. An image TS packet and a sound TS packet (first and second TS packets) read from the first and second memory areas AR1 and AR2 of the memory 220 are multiplexed by the host CPU 110 and generated as AVC data.

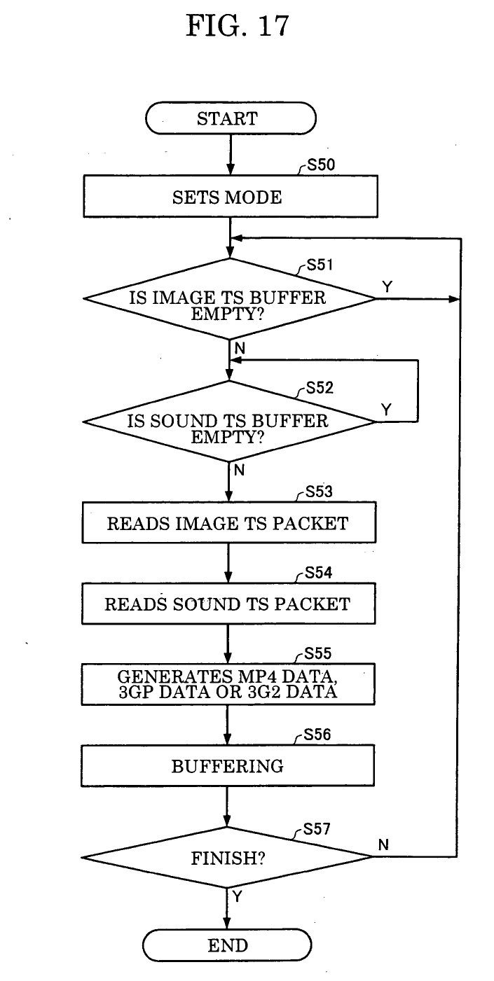

FIG. 17 is a flow diagram of a processing example of the host CPU 110 when generating AVC data. The host CPU 110 performs the processing shown in FIG. 17 by reading a program stored in the RAM 120 or the ROM 130 and performs processing corresponding to the program.

The host CPU 110 sets a given first recording mode in the image processing IC 200 (step S50). The image processing IC 200 includes a mode setting register (not shown). A control signal corresponding to the content set in the mode setting register is supplied to the image processing IC 200, and record processing corresponding to the set content is performed.

The host CPU 110 determines whether or not the first memory area AR1 of the memory 220 provided as an image TS buffer is empty (step S51). Note that the image processing IC 200 may notify the host CPU 110 of the empty state of the first memory area AR1 using an interrupt signal when the first memory area AR1 has become empty, or the host CPU 110 may periodically detect whether or not the first memory area AR1 is empty.

When the host CPU 110 has determined that the first memory area AR1 is not empty in the step S51 (step S51: N), the host CPU 110 determines whether or not the second memory area AR2 of the memory 220 provided as a sound ES buffer is empty (step S52). Whether or not the second memory area AR2 is empty may be detected in the same manner as the first memory area AR1. The step S51 is repeatedly performed insofar as the first memory area AR1 is empty (step S51: Y).

When the host CPU 110 has determined that the second memory area AR2 is not empty in the step S52 (step S52: N), the host CPU 110 reads the image TS packet from the first memory area AR1 of the memory 220 (step S53). The step S52 is repeatedly performed insofar as the second memory area AR2 is empty (step S52: Y).

After the step S53, the host CPU 110 reads the sound TS packet from the second memory area AR2 of the memory 220 (step S54).

The host CPU 110 analyzes the image TS packet and the sound TS packet, divides the packets into the time information, the payload of the image TS packet, and the payload of the sound TS packet, multiplexes the payload of the image TS packet and the payload of the sound TS packet according to time information to generate MP4 data, 3GP data or 3G2 data (step S55). The host CPU 110 then buffers the generated MP4 data, 3GP data or 3G2 data in the RAM 120, for example (step S56).

When finishing generating the MP4 data, the 3GP data or the 3G2 data (step S57: Y), the host CPU 110 finishes the processing (END). When continuously generating the MP4 data, the 3GP data or the 3G2 data (step S57: N), the host CPU 110 returns to the step S51.

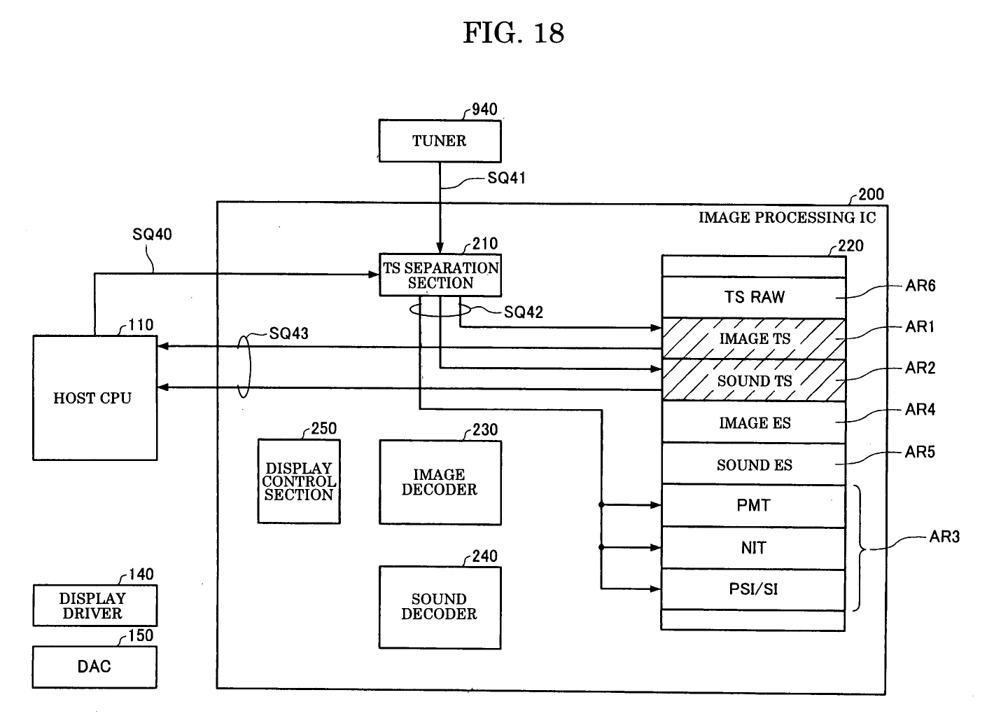

FIG. 18 is a view illustrative of the operation of the image processing IC 200 shown in FIGS. 6 and 7 when recording the MP4 data, the 3GP data or the 3G2 data. In FIG. 18, the same sections as in FIG. 10 are indicated by the same symbols. Description of these sections is appropriately omitted.

In FIG. 18, the fourth memory area AR4 is also used as the seventh memory area AR7, and the fifth memory area AR5 is also used as the eighth memory area AR8. The PSI/SI, NIT, and PMT are stored in specific memory areas in the third memory area AR3.

As shown in FIG. 9, the host CPU 110 sets the PID corresponding to the decode target program in the TS separation section 210 (SQ40). When a TS has been input from the tuner 940 (SQ41), the TS separation section 210 separates an image TS packet, a sound TS packet, and a TS packet other than the image TS packet and the sound TS packet from the TS from the tuner 940 (SQ42). The image TS packet separated by the TS separation section 210 is stored in the first memory area AR1. The sound TS packet separated by the TS separation section 210 is stored in the second memory area AR2. The TS packet other than the image TS packet and the sound TS packet separated by the TS separation section 210 is stored in the third memory area AR3 as PSI/SI. In this case, the TS separation section 210 extracts the NIT and the PMT from the PSI/SI and stores the NIT and the PMT in the third memory area AR3.

The host CPU 110 then directly accesses the first and second memory areas AR1 and AR2 of the memory 220, and reads the image TS packet and the sound TS packet, as shown in FIG. 17 (SQ43). The host CPU 110 generates MP4 data, 3GP data or 3G2 data, as described above, using the image TS packet and the sound TS packet read from the first and second memory areas AR1 and AR2 of the memory 220.

The above configuration allows the TS from the tuner 940 to be recorded as MP4 data, 3GP data or 3G2 data.

3.2.2 Recording AAC Data

Advanced Audio Coding (AAC) data is MPEG-2 Advanced Audio Coding (AAC) data (sound data). In this case, the TS separation section 210 extracts first and second TS packets based on analysis results from the host CPU 110 which analyzes a third TS packet extracted from a TS. AAC data is generated by the host CPU 110 using the sound TS packet (second TS packet) read from the second memory area AR2 of the memory 220.

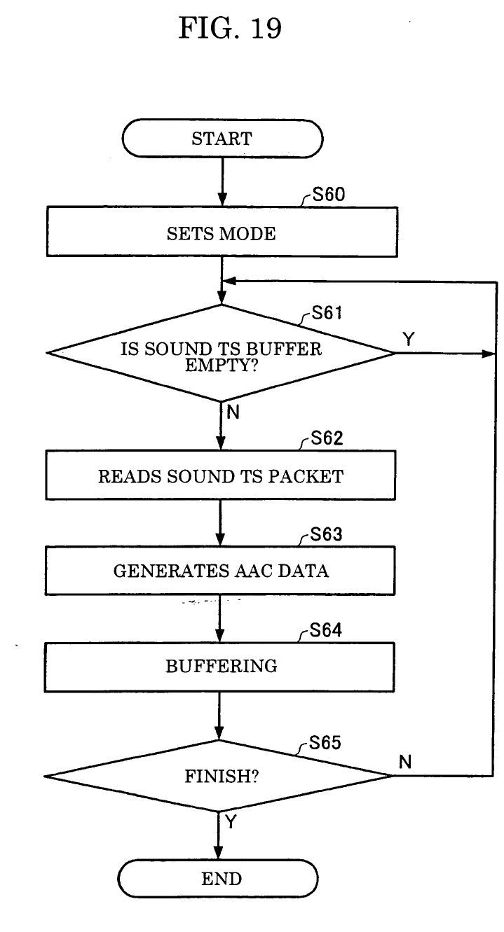

FIG. 19 is a flow diagram of a processing example of the host CPU 110 when generating AAC data. The host CPU 110 performs the processing shown in FIG. 19 by reading a program stored in the RAM 120 or the ROM 130 and performs processing corresponding to the program.

The host CPU 110 sets a given second recording mode in the image processing IC 200 (step S60). The image processing IC 200 includes a mode setting register (not shown). A control signal corresponding to the content set in the mode setting register is supplied to the image processing IC 200, and record processing corresponding to the set content is performed.

The host CPU 110 determines whether or not the second memory area AR2 of the memory 220 provided as a sound TS buffer is empty (step S61). Note that the image processing IC 200 may notify the host CPU 110 of the empty state of the second memory area AR2 using an interrupt signal when the second memory area AR2 has become empty, or the host CPU 110 may periodically detect whether or not the second memory area AR2 is empty.

When the host CPU 110 has determined that the second memory area AR2 is not empty in the step S61 (step S61: N), the host CPU 110 reads the sound TS packet from the second memory area AR2 of the memory 220 (step S62). The step S61 is repeatedly performed insofar as the second memory area AR2 is empty (step S61: Y).

After the step S62, the host CPU 110 generates AAC data using the sound TS packet (step S63). In more detail, the host CPU 110 analyzes the TS header of the sound TS packet to generate a PES packet, analyzes the PES header of the PES packet to generate the sound ES data (payload) as Audio Data Transport Stream (ADTS) AAC data.

The host CPU 110 then buffers the generated AAC data in the RAM 120, for example (step S64).

When finishing generating the AAC data (step S65: Y), the host CPU 110 finishes the processing (END). When continuously generating the AAC data (step S65: N), the host CPU 110 returns to the step S61.

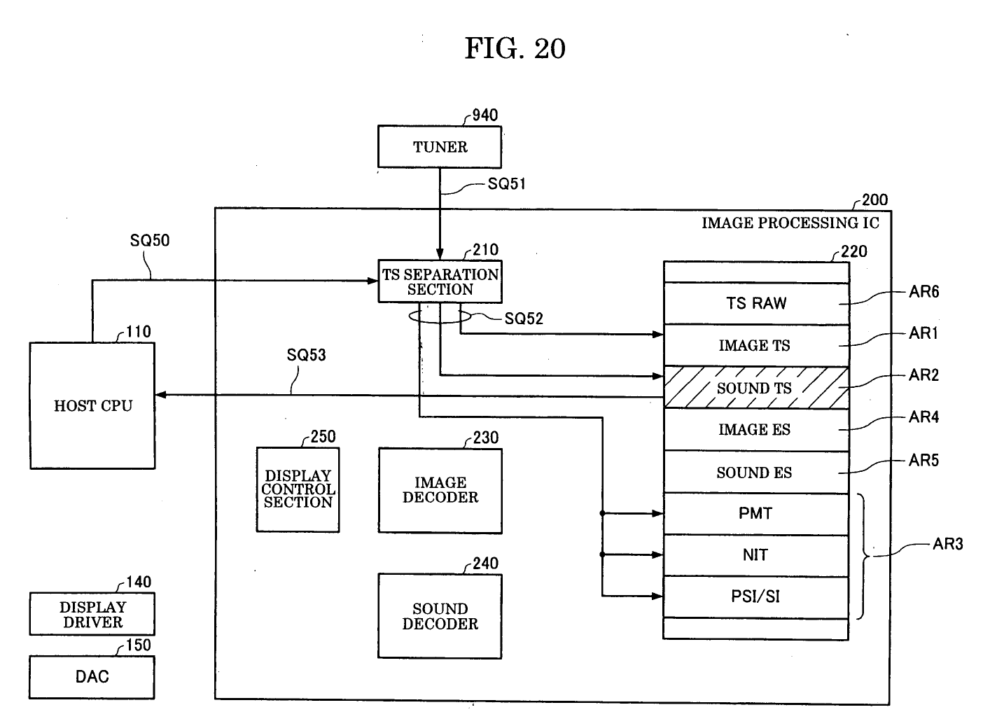

FIG. 20 is a view illustrative of the operation of the image processing IC 200 shown in FIGS. 6 and 7 when recording the AAC data. In FIG. 20, the same sections as in FIG. 10 are indicated by the same symbols. Description of these sections is appropriately omitted.

In FIG. 20, the fourth memory area AR4 is also used as the seventh memory area AR7, and the fifth memory area AR5 is also used as the eighth memory area AR8. The PSI/SI, NIT, and PMT are stored in specific memory areas in the third memory area AR3.

As shown in FIG. 9, the host CPU 110 sets the PID corresponding to the decode target program in the TS separation section 210 (SQ50). When a TS has been input from the tuner 940 (SQ51), the TS separation section 210 separates an image TS packet, a sound TS packet, and a TS packet other than the image TS packet and the sound TS packet from the TS from the tuner 940 (SQ52). The image TS packet separated by the TS separation section 210 is stored in the first memory area AR1. The sound TS packet separated by the TS separation section 210 is stored in the second memory area AR2. The TS packet other than the image TS packet and the sound TS packet separated by the TS separation section 210 is stored in the third memory area AR3 as PSI/SI. In this case, the TS separation section 210 extracts the NIT and the PMT from the PSI/SI and stores the NIT and the PMT in the third memory area AR3.

The host CPU 110 then directly accesses the second memory area AR2 of the memory 220, and reads the sound TS packet, as shown in FIG. 19 (SQ53). The host CPU 110 generates AAC data using the sound TS packet read from the second memory area AR2 of the memory 220, as described above.

The above configuration allows a TS from the tuner 940 to be recorded as AAC data.

3.2.3 Snap Shot

The image processing IC 200 extracts an image TS packet from a TS from the tuner 940 and performs image decoding to generate image data. The image processing IC 200 may compress still image data from the generated image data according to the Joint Photographic Experts Group (JPEG) standard, and record the compressed still image data. In this case, the TS separation section 210 extracts first and second TS packets based on analysis results from the host CPU 110 which analyzes a third TS packet extracted from a TS. The host CPU 110 generates compressed still image data from the image data generated as a result of decoding of the image decoder 230 based on the first TS packet.

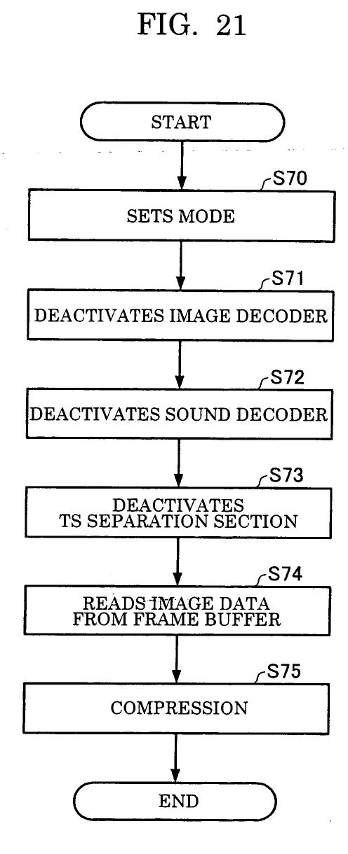

FIG. 21 is a flow diagram of a processing example of the host CPU 110 when generating compressed still image data. The host CPU 110 performs the processing shown in FIG. 21 by reading a program stored in the RAM 120 or the ROM 130 and performs processing corresponding to the program.

Note that the image processing IC 200 extracts an image TS packet and a sound TS packet from a TS from the tuner 940, and performs the reproduction processing as described above. In this case, image data generated by the image decoder 230 is stored in a frame buffer which is a memory area provided in the memory 220, and output to the display control section 250.

The host CPU 110 sets a given third recording mode in the image processing IC 200 in a state in which the image data is continuously generated (step S70). The image processing IC 200 includes a mode setting register (not shown). A control signal corresponding to the content set in the mode setting register is supplied to the image processing IC 200, and record processing corresponding to the set content is performed.

The host CPU 110 then suspends the operation of the image decoder 230 (step S71), and suspends the operation of the sound decoder 240 (step S72). The host CPU 110 also suspends the operation of the TS separation section 210 (step S73).

The host CPU 110 then reads the image data of one frame (one vertical scan) stored in the frame buffer provided in the memory 220 (step S74). The host CPU 110 compresses the image data according to the JPEG standard as still image data of one frame (step S75), and finish the processing (END).

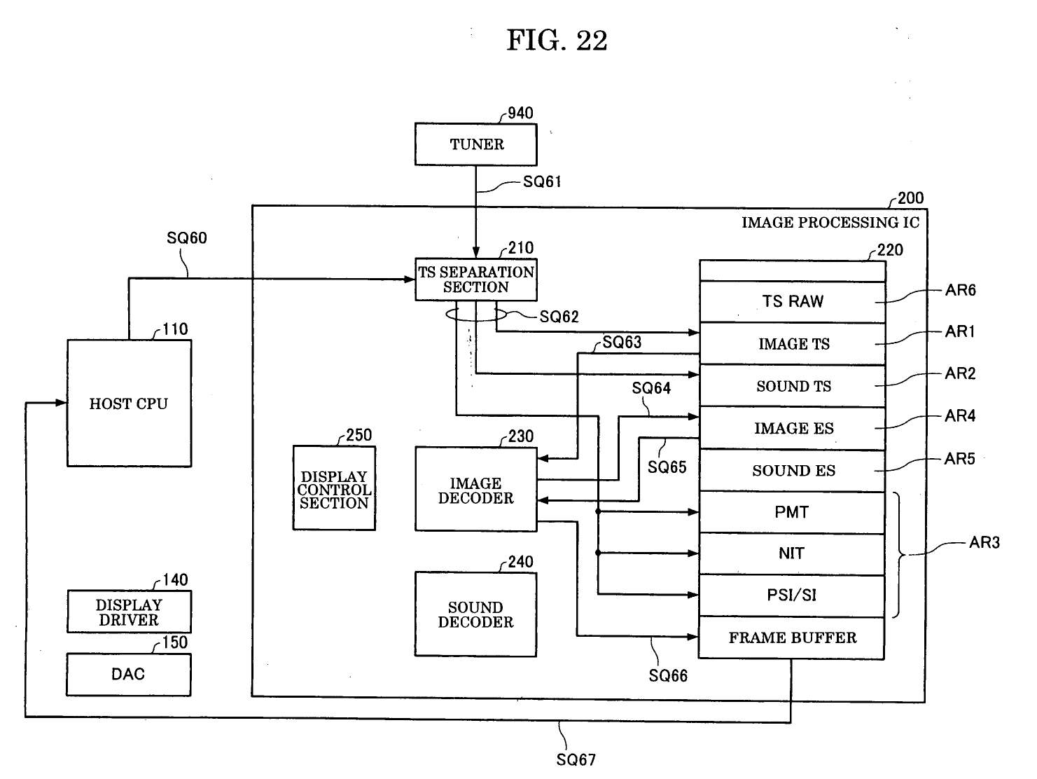

FIG. 22 is a view illustrative of the operation of the image processing IC 200 shown in FIGS. 6 and 7 when recording compressed still image data. In FIG. 22, the same sections as in FIG. 10 are indicated by the same symbols. Description of these sections is appropriately omitted.

In FIG. 22, the fourth memory area AR4 is also used as the seventh memory area AR7, and the fifth memory area AR5 is also used as the eighth memory area AR8. The PSI/SI, NIT, and PMT are stored in specific memory areas in the third memory area AR3.

As shown in FIG. 9, the host CPU 110 sets the PID corresponding to the decode target program in the TS separation section 210 (SQ60). When a TS has been input from the tuner 940 (SQ61), the TS separation section 210 separates an image TS packet, a sound TS packet, and a TS packet other than the image TS packet and the sound TS packet from the TS from the tuner 940 (SQ62). The image TS packet separated by the TS separation section 210 is stored in the first memory area AR1. The sound TS packet separated by the TS separation section 210 is stored in the second memory area AR2. The TS packet other than the image TS packet and the sound TS packet separated by the TS separation section 210 is stored in the third memory area AR3 as PSI/SI. In this case, the TS separation section 210 extracts the NIT and the PMT from the PSI/SI and stores the NIT and the PMT in the third memory area AR3.

The image decoder 230 reads the image TS packet from the first memory area AR1 (SQ63), generates image ES data, and stores the image ES data in the fourth memory area AR4 (SQ64).

The image decoder 230 then reads the image ES data from the fourth memory area AR4 (SQ65), and decodes the image ES data according to the H.264/AVC standard to generate image data. The image data is stored in the frame buffer of the memory 220 (SQ66), and supplied to the display control section 250.

When the host CPU 110 has been set in the third recording mode, the host CPU 110 suspends the operations of the image decoder 230, the sound decoder 240, and the TS separation section 210, as shown in FIG. 21. The host CPU 110 directly reads the image data of one frame (one vertical scan) from the frame buffer provided in the memory 220 as still image data of one frame (SQ67), and compresses the image data according to the JPEG standard. The compressed data is stored in the RAM 120.

The above configuration allows compressed still image data of a video image represented by image data to be recorded for a TS from the tuner 940.

3.2.4 Recording TS Data

TS data is data in which H.264/AVC data (image data), MPEG-2 Advanced Audio Coding (AAC) data (sound data), and other pieces of data are multiplexed. The TS data is stored by the host CPU 110 using the TS data read from the sixth memory area AR6 of the memory 220.

The invention is not limited to the above-described embodiments. Various modifications and variations may be made within the spirit and scope of the invention. The above embodiments and modifications illustrate examples which may be applied to digital terrestrial broadcasting. Note that the invention is not limited to an information reproduction device which may be applied to digital terrestrial broadcasting. The above embodiments and modifications illustrate the configurations which can reproduce image data and reproduction data. Note that the invention is not limited thereto. A configuration may also be employed which can merely record image data and reproduction data.

Some of the requirements of any claim of the invention may be omitted from a dependent claim which depends on that claim. Moreover, some of the requirements of any independent claim of the invention may be allowed to depend on any other independent claim.

Although only some embodiments of the invention are described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. An information recording device for recording data included in a transport stream, the information recording device comprising:
a separation section which extracts a first transport stream (TS) packet for generating image data as reproduction data, a second TS packet for generating sound data as reproduction data, and a third TS packet other than the first and second TS packets from the transport stream; and
a memory including a first memory area in which the first TS packet is stored, a second memory area in which the second TS packet is stored, and a third memory area in which the third TS packet is stored;
the separation section extracting the first and second TS packets based on analysis results of the third TS packet extracted from the transport stream; and
the first and second TS packets read from the first and second memory areas being multiplexed and generated as Moving Picture Experts Group phase 4 data, 3rd Generation Partnership Project data or 3rd Generation Partnership Project 2 data (MP4 data, 3GP data or 3G2 data).

2. An information recording device for recording data included in a transport stream, the information recording device comprising:
a separation section which extracts a first transport stream (TS) packet for generating image data as reproduction data, a second TS packet for generating sound data as reproduction data, and a third TS packet other than the first and second TS packets from the transport stream; and
a memory including a first memory area in which the first TS packet is stored, a second memory area in which the second TS packet is stored, and a third memory area in which the third TS packet is stored;
the separation section extracting the first and second TS packets based on analysis results of the third TS packet extracted from the transport stream; and
the second TS packet read from the second memory area being generated as Moving Picture Experts Group Phase 2 Advanced Audio Coding (MPEG-2 AAC) data.

3. An information recording device for recording data included in a transport stream, the information recording device comprising:
a separation section which extracts a first transport stream (TS) packet for generating image data as reproduction data, a second TS packet for generating sound data as reproduction data, and a third TS packet other than the first and second TS packets from the transport stream;
a memory including a first memory area in which the first TS packet is stored, a second memory area in which the second TS packet is stored, and a third memory area in which the third TS packet is stored; and
an image decoder which performs image decoding which generates image data based on the first TS packet read from the first memory area;
the separation section extracting the first and second TS packets based on analysis results of the third TS packet extracted from the transport stream; and
compressed still image data being generated based on the image data generated by the image decoder.

4. The information recording device as defined in claim 3,
wherein the memory includes a fourth memory area in which image elementary stream (ES) data is stored, the image ES data being obtained by deleting a packetized elementary stream (PES) header from a first PES packet generated using the first TS packet; and
wherein the image decoder deletes the PES header from the first PES packet, stores the image ES data in the fourth memory area, and performs the image decoding based on the image ES data read from the fourth memory area.

5. The information recording device as defined in claim 3, comprising:
a sound decoder which performs sound decoding which generates sound data based on the second TS packet read from the second memory area.

6. The information recording device as defined in claim 5,
wherein the memory includes a fifth memory area in which sound elementary stream (ES) data is stored, the sound ES data being obtained by deleting a packetized elementary stream (PES) header from a second PES packet generated using the second TS packet; and
wherein the sound decoder deletes the PES header from the second PES packet, stores the sound ES data in the fifth memory area, and performs the sound decoding based on the sound ES data read from the fifth memory area.

7. The information recording device as defined in claim 5,
wherein the image decoder reads the first TS packet from the first memory area independently of the sound decoder, and performs the image decoding based on the first TS packet; and
wherein the sound decoder reads the second TS packet from the second memory area independently of the image decoder, and performs the sound decoding based on the second TS packet.

8. An information recording device for recording data included in a transport stream, the information recording device comprising:
a memory including a sixth memory area in which TS data including a first transport stream (TS) packet for generating image data as reproduction data, a second TS packet for generating sound data as reproduction data, and a third TS packet other than the first and second TS packets is stored, the information recording device directly generating the TS data read from the sixth the memory area.

9. An electronic instrument comprising:
the information recording device as defined in claim 1; and
a host which analyzes the third TS packet extracted from the transport stream, and generates the AAC data, the MPEG-2 AAC data, or the compressed data.

10. An electronic instrument comprising:
the information recording device as defined in claim 2; and
a host which analyzes the third TS packet extracted from the transport stream, and generates the AAC data, the MPEG-2 AAC data, or the compressed data.

11. An electronic instrument comprising:
the information recording device as defined in claim 3; and
a host which analyzes the third TS packet extracted from the transport stream, and generates the AAC data, the MPEG-2 AAC data, or the compressed data.

12. An electronic instrument comprising:
the information recording device as defined in claim 8; and
a host which analyzes the third TS packet extracted from the transport stream, and generates the AAC data, the MPEG-2 AAC data, or the compressed data.

13. An electronic instrument comprising:
a tuner;
the information recording device as defined in claim 1 to which a transport stream from the tuner is supplied; and
a host which analyzes the third TS packet extracted from the transport stream, and generates the AAC data, the MPEG-2 AAC data, or the compressed data.

14. An electronic instrument comprising:
a tuner;
the information recording device as defined in claim 2 to which a transport stream from the tuner is supplied; and
a host which analyzes the third TS packet extracted from the transport stream, and generates the AAC data, the MPEG-2 AAC data, or the compressed data.

15. An electronic instrument comprising:
a tuner;
the information recording device as defined in claim 3 to which a transport stream from the tuner is supplied; and
a host which analyzes the third TS packet extracted from the transport stream, and generates the AAC data, the MPEG-2 AAC data, or the compressed data.

16. An electronic instrument comprising:
a tuner;
the information recording device as defined in claim 8 to which a transport stream from the tuner is supplied; and
a host which analyzes the third TS packet extracted from the transport stream, and generates the AAC data, the MPEG-2 AAC data, or the compressed data.
